(19) United States
(12) Patent Application Publication
(10) Pub. No.: US 2005/0050456 A1
(43) Pub. Date: Mar. 3, 2005

(54) Method and apparatus for supporting XML-based service consumption in a web presentation architecture

(76) Inventors: Brian James DeHamer, San Diego, CA (US); Peter Christopher Johnson II, Riverside, CA (US); Sankar Ram Sundaresan, San Jose, CA (US); Wayne Lee, Saratoga, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/652,469

(22) Filed: Aug. 29, 2003

(51) Int. Cl. G06F 15/00

(52) U.S. Cl. 715/513

(57) ABSTRACT

The disclosed embodiments relate to a system and method for creating web applications. The system comprises a controller generator that is adapted to provide a web application with a controller that receives requests for data from a user and responds to the requests by obtaining requested data. The system additionally comprises a web services interface generator that is adapted to provide a web services interface that formats a web service request, communicates the web service request to a web service and processes information received from the web service prior to providing the requested data to the user.

### BACKGROUND OF THE RELATED ART

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Web applications that allow a user to access data from external sources such as web services continue to grow in usefulness and popularity. Web services are programs dedicated to providing a particular function or service to users who request it. For example, a web service may be dedicated to providing the current temperature to a user who passes a request that includes locale information (such as a zip code). Web services may receive requests from users via a web application that is being employed by the user.

In some cases, web services are adapted to receive data in a format known as Extensible Markup Language (“XML”). Some web services further employ a services-invocation protocol called the Simple Object Access Protocol (“SOAP”), and a services-description language known as the Web Services Description Language (“WSDL”), which specifies additional formatting requirements. Other XML-based web services, however, do not employ SOAP for communication, or WSDL for description.

A potential problem with present architectures for web applications is that those architectures require developers of web applications to write extensive code to process a request to a web service if the web service does not support WSDL or SOAP. Typically, web application programmers who desire to access such web services must write code that receives information from the user, converts that information into the format required by the appropriate web service, transmits the request to the web service in the correct format, receives the response from the web service and unwraps the data from the web service so that it may be placed in a format for display to the user. The development of this code may be labor intensive and time consuming.

### BRIEF DESCRIPTION OF THE DRAWINGS

Advantages of one or more disclosed embodiments may become apparent upon reading the following detailed description and upon reference to the drawings in which:

FIG. 1 is a block diagram that illustrates a model-view-controller (“MVC”) application architecture, which may be created using embodiments of the present invention may be employed;

FIG. 2 is a block diagram that illustrates a web presentation architecture in accordance with embodiments of the present invention;

FIG. 3 is an object diagram that may be used to facilitate an XML-based web service consumer architecture in accordance with embodiments of the present invention; and

FIG. 4 is a block diagram that illustrates the operation of a web application program created using a web presentation architecture in accordance with embodiments of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

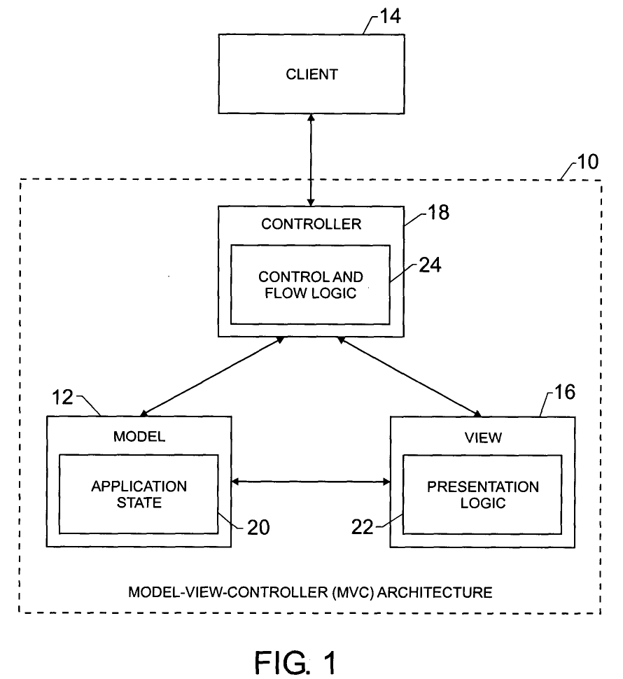

FIG. 1 is a block diagram that illustrates a model-view-controller (“MVC”) application architecture, which may be created using embodiments of the present invention. As illustrated, the MVC architecture 10 separates the application object or model 12 from a view 16, which is responsible for receiving input and presenting output to a client 14. In a web application context, the client 14 may comprise a browser. The model object and the view are also separated from the control functions of the application, which are represented in FIG. 1 as a controller 18. In general, the model 12 comprises an application state 20, the view 16 comprises presentation logic 22, and the controller 18 comprises control and flow logic 24. By separating these three MVC objects 12, 16, and 18 with abstract boundaries, the MVC architecture 10 provides flexibility, organization, performance, efficiency, and reuse of data, presentation styles, and logic.

The WPA 100 may be configured with a variety of object-oriented programming languages, such as Java by Sun Microsystems, Inc., Santa Clara, Calif. An object is generally any item that can be individually selected and manipulated. In object-oriented programming, an object may comprise a self-contained entity having data and procedures to manipulate the data. For example, a Java-based system may utilize a variety of JavaBeans, servlets, Java Server Pages, and so forth. JavaBeans are independent, reusable software modules. In general, JavaBeans support introspection (a builder tool can analyze how a JavaBean works), customization (developers can customize the appearance and behavior of a JavaBean), events (JavaBeans can communicate), properties (developers can customize and program with JavaBeans), and persistence (customized JavaBeans can be stored and reused). JSPs provide dynamic scripting capabilities that work in tandem with HTML code, separating the page logic from the static elements. According to certain embodiments, the WPA 100 may be designed according to the Java 2 Platform Enterprise Edition (J2EE), which is a platform-independent, Java-centric environment for developing, building and deploying multi-tiered Web-based enterprise applications online.

The model 12 comprises a definitional framework representing the application state 20. For example, in a web-based application, the model 12 may comprise a JavaBean object or other suitable means for representing the application state 20. Regardless of the application or type of object, an exemplary model 12 may comprise specific data and expertise or ability (methods) to get and set the data (by the caller). The model 12 generally focuses on the intrinsic nature of the data and expertise, rather than the extrinsic views and extrinsic actions or business logic to manipulate the data. However, depending on the particular application, the model 12 may or may not contain the business logic along with the application state. For example, a large application having an application tier may place the business logic in the application tier rather than the model objects 12 of the web application, while a small application may simply place the business logic in the model objects 12 of the web application.

As noted above, the view and controller objects 16 and 18 separately address these extrinsic views and actions or business logic. For example, the model 12 may represent data relating to a person (e.g., an address, a birth date, phone number, etc.), yet the model 12 is independent of extrinsic formats (e.g., a date format) for displaying the personal data or extrinsic actions for manipulating the personal data (e.g., changing the address or phone number). Similarly, the model 12 may represent data and expertise to track time (e.g., a clock), yet the model 12 is independent of specific formats for viewing the clock (e.g., analog or digital clock) or specific actions for manipulating the clock (e.g., setting a different time zone). These extrinsic formats and extrinsic actions are simply not relevant to the intrinsic behavior of the model clock object. One slight exception relates to graphical model objects, which inherently represent visually perceptible data. If the model 12 represents a particular graphical object, then the model 12 has expertise to draw itself while remaining independent of extrinsic formats for displaying the graphical object or extrinsic actions for creating or manipulating the graphical object.

The view 16 generally manages the visually perceptible properties and display of data, which may be static or dynamic data derived in whole or in part from one or more model objects 12. As noted above, the presentation logic 22 functions to obtain data from the model 12, format the data for the particular application, and display the formatted data to the client 14. For example, in a web-based application, the view 16 may comprise a Java Server Page (JSP page) or an HTML page having presentation logic 22 to obtain, organize, format, and display static and/or dynamic data. Standard or custom action tags (e.g.,jsp:useJavaBean) may function to retrieve data dynamically from one or more model objects 12 and insert model data within the JSP pages. In this manner, the MVC architecture 10 may facilitate multiple different views 16 of the same data and/or different combinations of data stored by one or more model objects 12.

The controller 18 functions as an intermediary between the client 14 and the model object 12 and view 16 of the application. For example, the controller 18 can manage access by the view 16 to the model 12 and, also, manage notifications and changes of data among objects of the view 16 and objects of the model 12. The control and flow logic 24 of the controller 18 also may be subdivided into model-controllers and view-controllers to address and respond to various control issues of the model 12 and the view 16, respectively. Accordingly, the model-controllers manage the models 12 and communicate with view-controllers, while the view-controllers manage the views 16 and communicate with the model-controllers. Subdivided or not, the controllers 18 ensure communication and consistency between the model 12 and view 16 and the client 14.

In operation, the control and flow logic 24 of the controller 18 generally receives requests from the client 14, interprets the client requests, identifies the appropriate logic function or action for the client requests, and delegates responsibility of the logic function or action. Requests may be received from the client via a number of protocols, such as Hyper Text Transfer Protocol (“HTTP”) or HTTP with Secure Sockets Layer (“HTTPS”). Depending on the particular scenario, the appropriate logic function or action of the controller 18 may include direct or indirect interaction with the view 16 and/or one or more model objects 12. For example, if the appropriate action involves alteration of extrinsic properties of data (e.g. reformatting data in the view 16), then the controller 18 may directly interact with the view 16 without the model 12. Alternatively, if the appropriate action involves alteration of intrinsic properties of data (e.g., values of data in the model 12), then the controller 18 may act to update the corresponding data in the model 12 and display the data in the view 16.

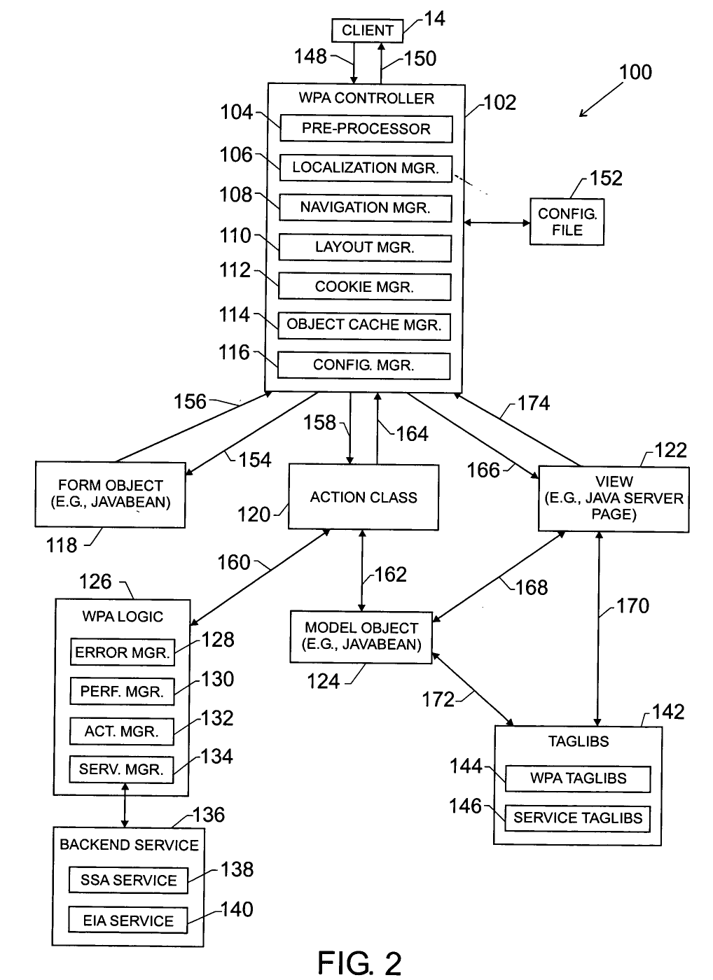

FIG. 2 is a block diagram illustrating an exemplary web presentation architecture (“WPA”) 100 in accordance with certain embodiments of the present invention. The illustrated WPA 100, which may be adapted to execute on a processor-based device such as a computer system or the like, has certain core features of the MVC computing strategy, and various additional features and enhancements to improve its architectural operation and performance. For example, the illustrated WPA 100 separates the model, the view, and the controller as with the traditional MVC architecture, yet the WPA 100 provides additional functionality to promote modularity, flexibility, and efficiency.

As illustrated, the WPA 100 comprises a WPA controller 102 having a preprocessor 104, a localization manager 106, the navigation manager 108, a layout manager 110, a cookie manager 112, and object cache manager 114, and a configurator or configuration manager 116. The WPA controller 102 functions as an intermediary between the client 14, form objects 118, action classes 120, and views 122. In turn, the action classes 120 act as intermediaries for creating/manipulating model objects 124 and executing WPA logic 126, such as an error manager 128, a performance manager 130, and activity manager 132, and a backend service manager 134. As described below, the backend service manager 134 functions to interface backend services 136. Once created, the model objects 124 can supply data to the view 122, which can also call various tag libraries 142 such as WPA tag libraries 144 and service tag libraries 146.

In operation, the client 14 sends a request 148 to the WPA 100 for processing and transmission of a suitable response 150 back to the client 14. For example, the request 148 may comprise a data query, data entry, data modification, page navigation, or any other desired transaction. As illustrated, the WPA 100 intakes the request 148 at the WPA controller 102, which is responsible for various control and flow logic among the various model-view-controller divisions of the WPA 100. For example, the WPA controller 102 can be implemented as a Servlet, such as a HyperText Transfer Protocol (“HTTP”) Servlet, which extends the ActionServlet class of Struts (an application framework promulgated by the Jakarta Project of the Apache Software Foundation). As illustrated, the WPA controller 102 invokes a configuration resource file 152, such as struts-config.xml, which provides mapping information for form classes, action classes, and other objects. Based on the particular request 148, the WPA controller 102 locates the appropriate action class and, also, the appropriate form class if the request 148 contains form data (e.g., client data input). For example, the WPA controller 102 may lookup a desired WPA Action Form and/or WPA Action Class, which function as interfaces to WPA Form Objects and WPA Action Objects.

If the client entered data, then the WPA controller 102 creates and populates the appropriate form object 118 as indicated by arrow 154. The form object 118 may comprise any suitable data objects type, such as a JavaBean, which functions to store the client entered data transmitted via the request 148. The WPA controller 102 then regains control as indicated by arrow 156.

If the client did not enter data, or upon creation and population of the appropriate form object 118, then the WPA controller 102 invokes the action class 120 to execute various logic suitable to the request 148 as indicated by arrow 158. For example, the action class 120 may call and execute various business logic or WPA logic 126, as indicated by arrow 160 and discussed in further detail below. The action class 120 then creates or interacts with the model object 124 as indicated by arrow 162. The model object 124 may comprise any suitable data object type, such as a JavaBean, which functions to maintain the application state of certain data. One example of the model object 124 is a shopping cart JavaBean, which stores various user data and e-commerce items selected by the client. However, a wide variety of model objects 124 are within the scope of the WPA 100. After executing the desired logic, the action class 120 forwards control back to the WPA controller 102 as indicated by arrow 164, which may be referred to as an “action forward.” This action forward 164 generally involves transmitting the path or location of the server-side page, e.g., the JSP.

As indicated by arrow 166, the WPA controller 12 then invokes the foregoing server-side page as the view 122. Accordingly, the view 122 interprets its links or tags to retrieve data from the model object 124 as indicated by arrow 168. Although a single model object 124 is illustrated, the view 122 may retrieve data from a wide variety of model objects. In addition, the view 122 interprets any special logic links or tags to invoke tag libraries 142 as indicated by arrow 170. For example, the WPA tag libraries 144 and the service tag libraries 146 can include various custom or standard logic tag libraries, such as <html>, <logic>, <template> developed as part of the Apache Jakarta Project or the like. Accordingly, the tag libraries 142 further separate the logic from the content of the view 122, thereby facilitating flexibility and modularity. In certain cases, the tag libraries 142 also may interact with the model object 124 as indicated by arrow 172. For example, a special tag may execute logic to retrieve data from the model object 124 and manipulate the retrieved data for use by the view 122. After interacting with the model object 124 and the appropriate tag libraries 142, the WPA 100 executes the view 122 (e.g., JSP) to create a client-side page for the client 14 as indicated by arrow 174. For example, the client-side page may comprise an XML or HTML formatted page, which the WPA controller 102 returns to the client 14 via the response 150.

As discussed above, the WPA 100 comprises a variety of unique logic and functional components, such as control components 104 through 116 and logic 128 through 134, to enhance the performance of the overall architecture and specific features 100. These components and logic generally operate on the server-side of the WPA 100, yet there are certain performance improvements that may be apparent on the client-side. These various components, while illustrated as subcomponents of the controller 102 or types of logic 126, may be standalone or integrated with various other portions of the WPA 100. Accordingly, the illustrated organization of these components is simply one exemplary embodiment of the WPA 100, while other organizational embodiments are within the scope of the present technique.

Turning to the subcomponents of the WPA controller 102, the preprocessor 104 provides preprocessing of requests by configuring portal specific functions to execute for each incoming request registered to the specific portal. The preprocessor 104 identifies the appropriate portal specific functions according to a preset mapping, e.g., a portal-to-function mapping in the configuration file 152. Upon completion, the preprocessor 104 can redirect to a remote Uniform Resource Identifier (URI), forward to a local URI, or return and continue with the normal processing of the request 148 by the WPA controller 102. One example of such a preprocessing function is a locale, which is generally comprised of language preferences, location, and so forth. The preprocessor 104 can preprocess local logic corresponding to a particular portal, thereby presetting language preferences for subsequent pages in a particular application.

The locale information is also used by the localization manager 106, which functions to render localized versions of entire static pages rather than breaking up the static page into many message strings or keys. Instead of using a single page for all languages and obtaining localized strings from other sources at run time, the localization manager 106 simply looks up a localized page according to a locale identifier according to a preset mapping, e.g., a locale-to-localized page mapping in the configuration file 152.

The navigation manager 108 generally functions to save a users intended destination and subsequently recall that information to redirect the user back to the intended destination. For example, if the user intends to navigate from point A to point B and point B queries for certain logic at point C (e.g., a user login and password), then the navigation manager 108 saves the address of point B, proceeds to the requested logic at point C, and subsequently redirects the user back to point B.

The layout manager 110 enables a portal to separate the context logic functioning to render the common context from the content logic functioning to render the content portion of the page. The common context (e.g., C-Frame) may include a top portion or header, a bottom portion or footer, and a side portion or sidebar, which collectively provides the common look and feel and navigational context of the page.

The cookie manager 112 functions to handle multiple cookie requests and to set the cookie value based on the most recent cookie request before committing a response. For example, in scenarios where multiple action classes attempt to set a particular cookie value, the cookie manager 112 caches the various cookie requests and defers setting the cookie value until response time. In this manner, the cookie manager 112 ensures that different action classes do not erase cookie values set by one another and, also, that only one cookie can exist with a particular name, domain, and path.

The object cache manager 114 enables applications to create customized in-memory cache for storing objects having data originating from backend data stores, such as databases or service based frameworks (e.g., Web Services Description Language “WSDL”). The in-memory cache may be customized according to a variety of criteria, such as cache size, cache scope, cache replacement policy, and time to expire cache objects. In operation, the object cache manager 114 improves performance by reducing processing time associated with the data from the backend data stores. Instead of retrieving the data from the backend data stores for each individual request 148, the object cache manager 114 caches the retrieved data for subsequent use in processing later requests.

The configurator or configuration manager 116 functions to load repeatedly used information, such as an error code table, into memory at startup time of a particular web application. The configuration manager 116 retains this information in memory for the duration of a session, thereby improving performance by eliminating the need to load the information each time the server receives a request.

Turning to the WPA logic 126, the error handler or manager 128 functions to track or chain errors occurring in series, catalog errors messages based on error codes, and displaying error messages using an error catalog. The error catalog of the error manager 128 may enable the use of generic error pages, which the error manager 128 populates with the appropriate error message at run time according to the error catalog.

The WPA logic function 126 may comprise performance and activity managers 130 and 132, which may facilitate tracking and logging of various information associated with a particular transaction or request. The error manager 128 may also be adapted to participate in tracking and logging operations as well.

The service manager 134 of the WPA logic 126 functions as an interface between the WPA 100 and various backend services 136. In operation, the service manager 134 communicates with the desired backend service 136 according to the client request 148, parses a response from the backend service 136 to obtain the appropriate data, and pass it to the appropriate object of WPA 100.

The following discussion relates to the aspects of the architecture of the present invention that provide application developers with the ability to effectively incorporate access to web services into web applications. For purposes of example, the web services described herein are extensible markup language XML-based web services that do not employ WSDL or SOAP. The mechanism that facilitates access to XML-based web services may be referred to as an XML service consumer, which may be incorporated into the action classes referred to above.

The XML service consumer is a feature of web applications created in accordance with embodiments of the present invention. The architecture used to create the XML service consumer automatically generates code that prepares a request to an XML-based web service, generates the request to the XML service in the correct format and manages the data received back from the web service so that it may be displayed to the user of the web application. Configuration information for each web service that is to be accessible by the web application may be contained in a file (such as an XML file) associated with the web application. If access to the web application is possible from a plurality of web portals, different XML files may be used to specify different web services that are usable with each of the plurality of portals.

One goal of the XML service consumer is to create a generic mechanism by which web applications constructed according to embodiments of the present invention may use XML-based protocols to communicate with back end systems such as web services. The operation of an XML-based service protocol typically involves the following steps:
1. Enclose a request payload in one or more protocol-specific XML envelopes.
2. Transmit the request via a protocol such as the Hyper Text Transport Protocol (“HTTP”).
3. Strip off one or more protocol-specific XML envelopes enclosing the response payload.
4. Unmarshal the XML response payload into some object representation (such as a Java object).

By creating standard interfaces for envelope and payload processing, the XML service consumer may allow any number of protocol-specific implementations to be built. Action classes, which may be referred to as “actors,” may include the following:

ConfiguratorController—Object responsible for launching all other Configurators registered with the system. The ConfiguratorController object may be executed as part of the init( ) method of the controller. Configurators may be responsible for reading a plurality of XML files prior to run time of the web application. In this manner, a web application prepared from architectures in accordance with embodiments of the present invention may be made aware of the various services and associated data parameters that may be used by various portals to provide users with access to the web application.

XMLActionConfigurator—Configurator responsible for locating and processing all configuration files such as “xml-action-config.xml” files. The contents of the “xml-action-config.xml” files may be used to populate the RequestMappings and ResponseMappings collections.

XMLHostConfigurator—Configurator responsible for locating and processing all of the “xml-hosts.xml” files. The contents of the “xml-host.xml” files may be used to populate the HostMappings collection.

xml-action-config.xml—Configuration file responsible for enumerating the envelope processors and payload processors associated with different services.

xml-hosts.xml—Configuration file responsible for enumerating the host, port and path information required to connect with different XML service providers.

RequestMapping—Bean used to hold list of envelope processors associated with a particular service.

RequestMappings—Singleton collection used to hold all of the RequestMapping objects. A singleton collection is a collection of objects that are defined at initialization and may be accessible to a variety of web applications via a variety of portals during run time.

ResponseMapings—Singleton collection used to associate a response type with a payload processor.

HostMapping—Bean used to hold the host, port and path information required to connect with a particular XML service.

HostMappings—Singleton collection used to hold all of the HostMapping objects.

XMLActionForm—Subclass of ActionForm responsible for instantitating and populating the RequestMessage object with the appropriate request payload information. The XMLActionForm may be instantiated in the same manner as standard ActionForm objects.

XMLAction—Action class that can be used to connect to any XML-based protocol.

RequestMessage—Bean that generically describes a pending XML service request. The RequestMessage bean may contain properties that represent the service name, service version and request payload.

ResponseMessage—Bean that generically describes response received from an XML service request. The ResponseMessage bean may contain properties that represent the response type, service version and response payload.

EnvelopeProcessor—Object responsible for producing and consuming protocol-specific XML envelope information.

PayloadProcessor—Object responsible for parsing/processing the response payload after all of the envelope processors have been executed.

The above-identified actors may be used to configure a web application for operation with a particular XML service. In such a configuration, the following may comprise a typical course of events. The controller may be initialized, which may cause the ConfiguratorController to execute. Two of the Configurators that are launched are XMLActionConfigurator and the XMLHostConfigurator. Next, the XMLActionConfigurator may iterate over all the service directories looking for a configuration file named “xml-action-config.xml”.

Every <request> element found in the xml-action-config.xml file may be used to instantiate and populate a new RequestMapping object. The RequestMapping object keeps track of envelope processors associated with a particular service name. Each RequestMapping object that may be created and added to the singleton RequestMappings collection.

Every <response> element found in the xml-action-config.xml file may be used to add a new item to the singleton ResponseMappings collection. The ResponseMappings collection may associate a response type with a payload processor.

The XMLHostConfigurator may iterate over all the service directories looking for files named “xml-hosts.xml.” Every <host> element found in the xml-hosts.xml file may be used to instantiate and populate a new HostMapping object. The HostMapping object may keep track of the host, port and path information needed to communicate with an XML service. Each HostMapping object that is created may be added to the singleton HostMappings collection.

After configuration, the defined actors may be used to access an XML-based web service in response to a request. Based on the configuration settings, requests for XML services may be created and sent to the correct location (web service). Responses from the web service may be processed so that information embodied in the response from the web service may be displayed to the requesting user. The following example describes the processing of a user request by a web application created using an architecture in accordance with embodiments of the present invention.

An HTTP request may be received and mapped by a configuration file to an Action class (XMLAction, for example) and its associated Action Form (a sub-class of XMLActionForm, for example). The appropriate XMLActionForm object may be initialized and passed as a parameter to the perform( ) method of the XMLAction object.

XMLAction may call the getRequestMassage( ) method of the XMLActionForm object in order to retrieve the RequestMessage object. Next, the getRequestMessage( ) method may instantiate a new RequestMessage object and populate it with the an appropriate service name, service version and content values. Using the service name property of the RequestMessage object as the look-up key, XMLAction may retrieve the RequestMapping object from the RequestMappings collection.

Next, the XMLAction object may retrieve the list of envelope processors from the RequestMapping object and call the preprocess( ) method of each EnvelopeProcessor, passing the RequestMessage in as a parameter. Using the server name and port number retrieved from the HostMappings collection, a socket connection is opened and the content of the RequestMessage object is transmitted via an HTTP Post request. A new ResponseMessage object is instantiated and populated with the result of the HTTP Post.

XMLAction may retrieve the list of envelope processors from the RequestMapping object and call (in reverse order) the postprocess( ) method of each EnvelopeProcessor, passing the ResponseMessage in as a parameter. XMLAction may retrieve the name of the PayloadProcessor object from the ResponseMappings collection and call the executes method on that object, passing the ResponseMessage in as a parameter.

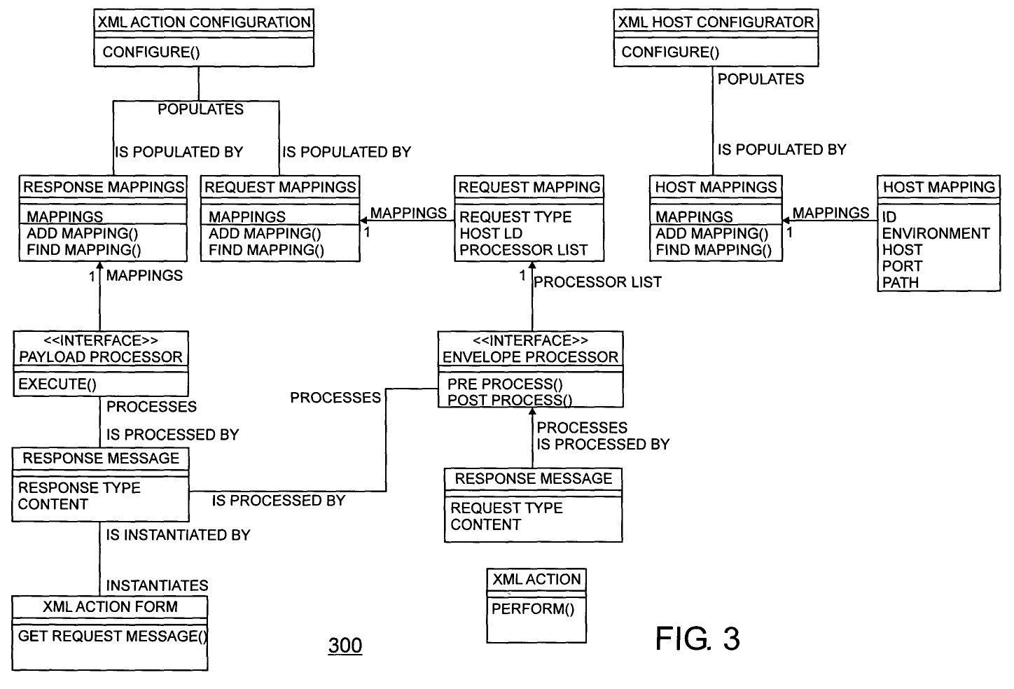

The object returned from the execution of the execute( ) method of the PayloadProcvessor object may be stored in a known location in Request scope. The response type property of the ResponseMessage object may be used to look up the ActionForward that is returned from XMLAction. This example may be better understood in conjunction with FIG. 3, which is an object diagram.

FIG. 3 is an object diagram that may be used to facilitate an XML-based web service consumer architecture in accordance with embodiments of the present invention. The diagram is generally referred to by the reference numeral 300. FIG. 3 is useful in identifying the relationship between various objects referred to in the above examples.

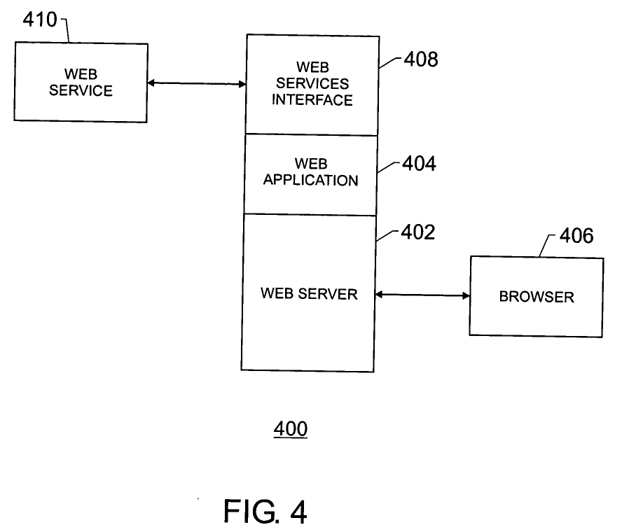

FIG. 4 is a block diagram that illustrates the operation of a web application program created using a web presentation architecture in accordance with embodiments of the present invention. The diagram is generally referred to by the reference numeral 400. A web server 402 is adapted to execute a web application 404 that has been constructed using an architecture according to embodiments of the present invention. The web application 404 comprises a web services interface 408 that is adapted to communicate with a web service 410. The web service 410 may be located on a server that is external to the web server 402.

The web application 404 is adapted to receive requests from a user. These requests may be delivered to the web application 404 by a browser 406. The request to the web application 404 may be an HTTP request. The request from the user does not necessarily include a direct request for access to the web service 410. Instead, the web application 404 may be designed to access the web service 410 to retrieve information that may be used to process the request of the user. Alternatively, the information requested from the web service may not be directly related to the request of the user, but may be believed by the designer of the web application 404 to be of interest to the user. For example, the information requested from the web service 410 may comprise a temperature for the locale of the user or the like. The temperature data retrieved from the web service 410 may be displayed in conjunction with the data that is specifically requested by the user.

One or more parameters required by the web service 410 may be contained in the request from the user either directly (user input, for example) or indirectly (from a cookie, for example). Alternatively, the parameters required by the web service 410 may be provided directly by the web application 404 or the web services interface 408. Those parameters may be contained in a configuration file, which may be an XML file.

The web services interface 410 may be responsible for formulating a web services request in the format required to communicate with the web service 410. The web services interface 410 may also communicate the web services request to the web service 408 and process information received from the web service 408 in response to the web service request. The web services interface 410 may provide the information to the web application 404 in a format that is usable by the web application 404 to display the information to the user.

The following examples of code represent various aspects of a web presentation architecture in accordance with embodiments of the present invention. Those of ordinary skill in the art will appreciate that these code examples are given for purposes of illustration only, and not by way of limitation. The following example code may be employed to request a payload:

```
<Add xmlns=“http://xyz.com/”>
    <a>2</a>
    <b>3</b>
</Add>
```

The following example code may be employed to add a SOAP envelope to a request to an XML-based web service:

```
<?xml version=“1.0” encoding=“utf-8”?>
<soap:Envelope
    xmlns:xsi=“http://www.w3.org/2001/XMLSchema-instance”
    xmlns:xsd=“http://www.w3.org/2001/XMLSchema”
    xmlns:soap=“http://schemas.xmlsoap.org/soap/envelope/”>
        <soap:Body>
            <Add xmlns=“http://xyz.com/”>
                <a>2</a>
                <b>3</b>
            </Add>
        </soap:Body>
</soap:Envelope>
```

The following example code may be employed to add an HTTP envelope to a request to an XML-based web service:

```
Content-Type: text/xml; charset=utf-8
Content-Length: 300
SOAPAction: http://xyz.com/Add
<?xml version=“1.0” encoding=“utf-8”?>
<soap:Envelope
    xmlns:xsi=“http://www.w3.org/2001/XMLSchema-instance”
    xmlns:xsd=“http://www.w3.org/2001/XMLSchema”
    xmlns:soap=“http://schemas.xmlsoap.org/soap/envelope/”>
        <soap:Body>
            <Add xmlns=“http://xyz.com/”>
                <a>2</a>
                <b>3</b>
            </Add>
        </soap:Body>
</soap:Envelope>
```

The following example code may be employed to respond to a request to an XML-based web service:

```
HTTP/1.1 200 OK
Server: Microsoft-IIS/5.1
Date: Sat, 08 Jun 2002 20:18:09 GMT
Cache-Control: private, max-age=0
Content-Type: text/xml; charset=utf-8
<?xml version=“1.0” encoding=“utf-8”?>
<soap:Envelope
    xmlns:soap=“http://schemas.xmlsoap.org/soap/envelope/”
    xmlns:xsi=“http://www.w3.org/2001/XMLSchema-instance”
    xmlns:xsd=“http://www.w3.org/2001/XMLSchema”>
        <soap:Body>
            <AddResponse xmlns=“http://xyz.com/”>
                <AddResult>5</AddResult>
            </AddResponse>
        </soap:Body>
</soap:Envelope>
```

The following example code may be employed to remove an HTTP envelope from a response received from an XML-based web service:

```
<?xml version=“1.0” encoding=“utf-8”?>
<soap:Envelope
    xmlns:soap=“http://schemas.xmlsoap.org/soap/envelope/”
    xmlns:xsi=“http://www.w3.org/2001/XMLSchema-instance”
    xmlns:xsd=“http://www.w3.org/2001/XMLSchema”>
        <soap:Body>
            <AddResponse xmlns=“http://xyz.com/”>
                <AddResult>5</AddResult>
            </AddResponse>
        </soap:Body>
</soap:Envelope>
```

The following example code may be employed to remove a SOAP envelope from a response received from an XML-based web service:

<AddResponse xmlns=“http://xyz.com/”>
<AddResult>5</AddResult>
</AddResponse>

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

1. A system for creating web applications, the system comprising:
a controller generator that is adapted to provide a web application with a controller that receives requests for data from a user and responds to the requests by obtaining requested data; and
a web services interface generator that is adapted to provide a web services interface that formats a web service request, communicates the web service request to a web service and processes information received from the web service prior to providing the requested data to the user.

2. The system set forth in claim 1, wherein the web application is adapted to load configuration information about the web service from a configuration file.

3. The system set forth in claim 2, wherein the configuration file is an extensible markup language (“XML”) file.

4. The system set forth in claim 1, wherein the web services interface communicates with a plurality of web services.

5. The system set forth in claim 1, wherein the web services interface delivers a parameter received from the user to the web service.

6. The system set forth in claim 5, wherein the parameter received from the user is contained in a cookie.

7. The system set forth in claim 1, wherein the web application is adapted to receive input from a plurality of web portals.

8. A method of creating web applications, the method comprising:
creating, with a processor-based device, a controller that receives requests for data from a user and responds to the requests by obtaining requested data; and
providing a web services interface for a web application, the web services interface being adapted to format a web service request, communicate the web service request to a web service and process information received from the web service prior to providing the requested data to a user.

9. The method set forth in claim 8, comprising defining a web services interface generator that provides web applications that are adapted to load configuration information about the web service from a configuration file.

10. The method set forth in claim 9, comprising defining the configuration file to be an extensible markup language (“XML”) file.

11. The method set forth in claim 8, comprising defining a web services interface generator that allows the web services interface to communicate with a plurality of web services.

12. The method set forth in claim 8, comprising defining a web services interface generator that allows the web services interface to deliver a parameter received from the user to the web service.

13. The method set forth in claim 12, comprising defining a cookie to provide the parameter to the web services interface.

14. The method set forth in claim 8, comprising defining a web services interface generator that provides web applications that are adapted to receive input from a plurality of web portals.

15. A system for creating web applications, the system comprising:
means for creating a controller that provides control functions for a web application, the controller being adapted to receive requests for data from a user and respond to the requests by obtaining requested data; and
means for providing a web services interface that formats a web service request, communicates the web service request to a web service and processes information received from the web service prior to providing the requested data to the user.

16. The system set forth in claim 15, wherein the web application is adapted to load configuration information about the web service from a configuration file.

17. The system set forth in claim 16, wherein the configuration file is an extensible markup language (“XML”) file.

18. The system set forth in claim 15, wherein the web services interface communicates with a plurality of web services.

19. The system set forth in claim 15, wherein the web services interface delivers a parameter received from the user to the web service.

20. A program for creating a web application, the program comprising:
a machine readable medium;
a controller generator stored on the machine readable medium, the controller generator being adapted to provide the web application with a controller that receives requests for data from a user and responds to the requests by obtaining requested data; and
a web services interface generator stored on the machine readable medium, the web services interface generator being adapted to provide a web services interface that formats a web service request, communicates the web service request to a web service and processes information received from the web service prior to providing the requested data to the user.
